(19) United States
(12) Patent Application Publication
(10) Pub. No.: US 2008/0034639 A1
(43) Pub. Date: Feb. 14, 2008

(54) Decoy cover

(76) Inventor: Greg Abbas, Beaverton, MI (US)

Correspondence Address: MCKELLAR IP LAW, PLLC, 784 SOUTH POSEYVILLE ROAD, MIDLAND, MI, 48640, US

(21) Appl. No.: 11/974,390

(22) Filed: Oct. 11, 2007

Related U.S. Application Data
(63) Continuation-in-part of application No. 11/280,555, filed on Nov. 16, 2005.

(51) Int. Cl. A01M 31/06

(52) U.S. Cl. 43/2

(57) ABSTRACT

A decoy cover and a decoy that has the decoy cover and consists of, in one embodiment, simulated feathers and in another embodiment, real feathers. The cover is easily attachable and removable. The near end of the covering is placed around the head portion of the outer casing of a decoy and the distal end attaches around the tail portion. There is a strap around the middle section that secures the outer casing to the main body housing. In the first embodiment, there are at least two rod extensions that originate from the main body that pass through the outer covering extending outwardly, with simulated feathers attached at the end. The feathers that are attached to the end can move even in the gentlest breeze creating the appearance of movement of the fowl.

This is a Continuation-in-Part application of U.S. Ser. No. 11/280,555, filed Nov. 16, 2005, now pending.

### BACKGROUND OF INVENTION

The present invention is a decoy cover that simulates or imitates fowl and the like through the use of simulated plumage based on the fowl that is being imitated.

The inventor is unaware of any prior art directly related to the invention. The majority of decoys imitating fowl are molded with plumage patterns existing as part of the mold pattern. Then the detail is added through the application of color. In one embodiment, the instant invention uses an outer covering that has simulated feathers attached to it imitating real fowl plumage, and in another embodiment, there is used real feathers.

U.S. Pat. No. 6,092,322 issued on Jul. 25, 2000 to Samaras describes a decoy with moveable parts, including a head and neck portion that is suspended from the main body that can interact with naturally occurring air currents. Also it suggests a plastic sheet attached to the main body where the natural air currents give the plastic sheet movement simulating feathers.

U.S. Pat. No. 6,487,810 issued on Dec. 2, 2002 to Loughman describes a decoy with a separate tail section using tail feathers that are manually operated. This device is not attached to the main body and has to be manually operated.

U.S. Pat. No. 6,775,943 issued on Aug. 17, 2004 to Loughman describes a decoy with a separate tail section using tail feathers that are manually operated. The idea is to imitate movement of the tail to attract Wild turkeys.

### THE INVENTION

The essence of the invention is a decoy cover. The decoy cover is comprised of a main body that has an outside surface and is capable of being configured to the outside surface of a decoy. The decoy cover has a neck end, a tail end and a middle portion with the neck end, tail end and middle portion having a fastening means for fastening the cover to a model of the fowl.

In one embodiment, the outside surface of the decoy cover is primarily comprised of artificial feathers that are attached to it. The feathers that are attached to the outside surface mimic the feathers of real fowl. The outside surface has artificial feathered wings attached near the middle portion. The wings have a leading edge and the wings trail rearward toward the tail end of the decoy cover.

The decoy has a flexible rod transversing through the middle portion and forward of the leading edge of the wings. The flexible rod protrudes beyond the wings with each end having an attachment means for attaching at least one moveable feather such that each of the moveable feathers is free to move by air current.

In another embodiment, there is a decoy cover comprising a main body, having an outside surface. The main body is capable of being configured to the outside surface of a decoy and the decoy cover has a neck end and a tail end and a middle portion.

The neck end, tail end, and middle portion have a fastening means located on it and the outside surface of the decoy cover is comprised primarily of real feathers attached thereto, said feathers mimicking the feathers of a fowl.

The outside surface has feathered wings attached to it and near the middle portion thereof, said wings having a leading edge and said wings trailing rearward toward the tail end of the decoy cover, said wings composed of real feathers.

### BRIEF DESCRIPTION OF THE DRAWINGS

FIG. 1 is a full side view of a standard turkey decoy with the decoy cover attached FIG. 2 is a full top view of the decoy cover not mounted to a decoy showing the one form of the attaching means.

FIG. 3 is an illustration of a decoy cover of this invention wherein the decoy cover is covered with real fowl feathers.

### DETAILED DESCRIPTION OF THE DRAWINGS

It should be understood that a “fastening means” includes the use of one of the following methods of attachment: Velcro®, button, hook and loop, hook and eye, clasp, hasp, snap, buckle, zipper, lock, latch, pin, tack, staple, sew, stitch, batten, batten down, glue, strap, wire, belt, band, tape, catch, clamp, clip, cleat, hitch, interlock, hook, loop, thumb tack, tie, and oxreim.

The use of the term “primarily” refers to the area of coverage of the feathered portion of the covering. That should be understood to mean that it can be from less that 10 percent to 100 percent.

The term “fowl” is defined herein as a bird of any kind. “Flexible rod” is defined herein as a rod made of plastic, metal, wood, fiberglass, graphite and rubber that will tolerate a slight bend, for example on the order of up to 10 percent deviation from the normal linear axial alignment of the rod. “Transversing” as used herein means across the fowl from side to side. “Protruding beyond the wings” as used herein means extending outward away from the decoy and the decoy cover. “Attachment means” for the moveable feathers is defined herein as meaning attached to the outside surface or attached to the inside surface and penetrating through the cover and extending outwardly away from the cover. Such means of attachment includes glue, sewing, tying, hooking, pinning, such as by a safety pin, adhesion, stapling, tacking, wiring, molding, grafting, cementing, knitting, stitching, taping, and bonding.

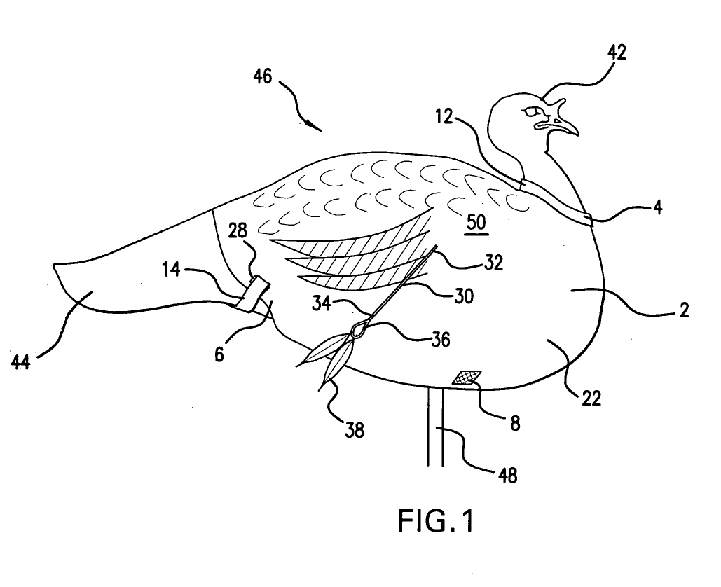

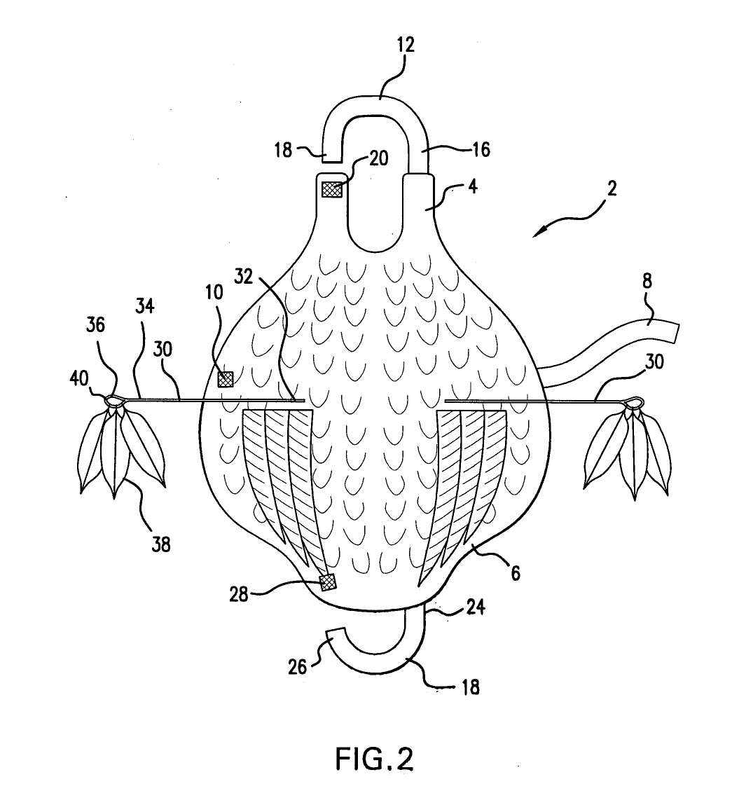

Now, turning to the description of the invention in which a turkey is the model fowl, FIG. 1 shows a full side view of a standard turkey decoy 46 with the decoy cover 2 attached. The standard turkey decoy 46 has a head portion 42 a main body portion 22 and a tail portion 44. The decoy 46 is surmounted to a decoy stand 48 inserted into the ground. The decoy cover 2 is placed over the decoy 46. The near end 4 of decoy cover 2 is surmounted just below the head portion 42 over the main body portion 22 and the distal end 6 of decoy cover 2 rests just above the tail portion 44. Shown are two arcuate configurations as a means of attachment. The first arcuate configuration 12 loops essentially under the head portion 42. The second arcuate configuration 14 loops essentially above the tail portion 44. Also visible are the. extensions 30. The extensions 30 have a near end 32 and a distal end 34. The near end 32 is attached to the inside surface 50 of decoy cover 2 extending through the decoy cover 2 outwardly where the distal end 34 terminates in a ringed portion 36. Attached to the ringed portion 36 is a simulated feather attachment point 40 where simulated feathers 38 are attached. The feathers 38 that are attached to the decoy cover 2 give the appearance of actual feathers that can react with just a slight breeze, allowing movement and providing a realistic feature that is not available with molded decoys. The feathers that are attached to the extensions 30 give a realistic feature of wing movement that is also not available with molded decoys. The simulated feathers 38 are preferably manufactured from plastics and attached to the outer surface 50 of the cover 2. However, the feathers can be made from cloth, plastics, or other suitable materials and attached to the outside surface 50.

FIG. 2 is a full top view of the decoy cover 2, not mounted to a decoy, showing the first arcuate configuration 12 and the second arcuate configuration 14 detached. The near end 4 of decoy cover 2 has the near end 16 of the first arcuate configuration 12 attached to it. The first arcuate configuration 12 distal end 18 attaches to attachment point 20. The distal end 6 of decoy cover 2 has the near end 24 of the second arcuate 20 configuration 14 attached to it. The distal end 26 of the second arcuate configuration 26 attaches to attachment point 28.

The decoy cover 2 has a strap 8 attached to it, essentially at the mid-portion . The strap 8 wraps around the main body 22 of decoy 46 attaching to attachment point 10. The extension 30 is attached to the inside surface 50 of the decoy cover 2. The near end 32 of the extension 30 extends outwardly through the decoy cover 2 terminating in a ringed portion 36 of the distal end 34. The ringed portion 36 of the extension 30 has attachment points 40 that contain simulated feathers 38. These simulated feathers 38 are attached to the entire outside surface 52 of the decoy cover 2.These simulated feathers 38 give the appearance of a more natural look to a standing decoy. The gentlest of breezes will ruffle the feathers giving it more animation then a typical decoy.

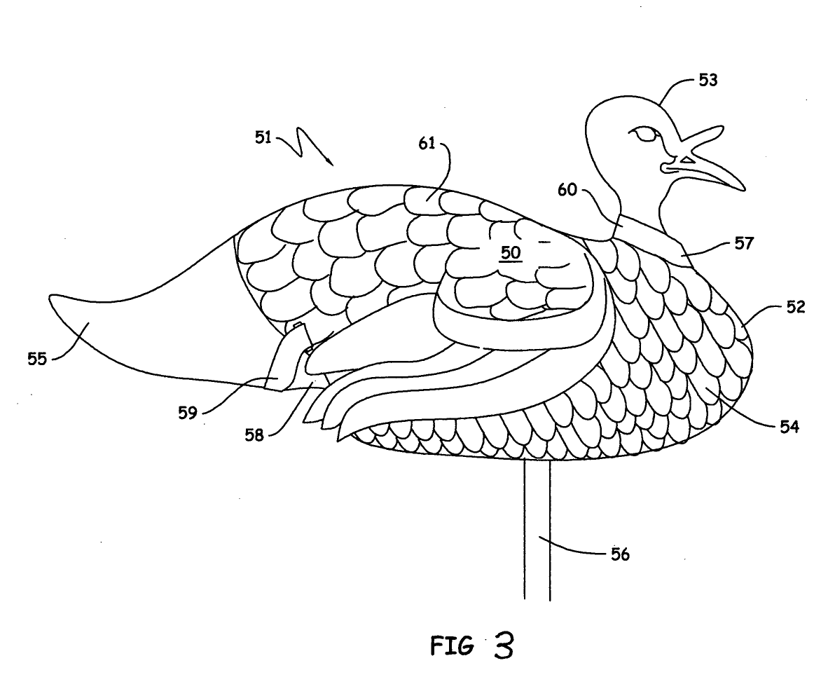

Now, turning to the description of the other embodiment of this invention in which the model fowl is a turkey, FIG. 3 shows a full side view of a standard turkey decoy 51 with the decoy cover 52 attached. The standard turkey decoy 51 has a head portion 53 a main body portion 54 and a tail portion 55. The decoy 51 is surmounted on a decoy stand 56 inserted into the ground. The decoy cover 52 is placed over the decoy 51. The near end 57 of decoy cover 52 is mounted just below the head portion 53 over the main body portion 54 and the distal end 58 of decoy cover 52 rests just above the tail portion 55. Shown are two arcuate configurations as a means of attachment. The first arcuate configuration 59 loops essentially under the head portion 53. The second arcuate configuration 60 loops essentially above the tail portion 55.

The feathers 61 that are attached to the decoy cover 52 give the appearance of actual fowl and allow movement for providing a realistic feature that is not available with molded decoys.

The feathers are attached to the outside surface of the decoy cover 52 by adhesives, or by sewing, or by any convenient means. Because they are real feathers, they have the iridescence of real feathers that cannot be achieved by any other means.

What is claimed is:

1. A decoy cover, said decoy cover comprising a main body, having an outside surface,
said main body being capable of being configured to the outside surface of a decoy;
said decoy cover having a neck end and a tail end and a middle portion;
said neck end, tail end, and middle portion having a fastening means located thereon;
the outside surface of the decoy cover is comprised primarily of artificial feathers attached thereto, said feathers mimicking the feathers of a fowl;
the outside surface having artificial feathered wings attached thereto and near the middle portion thereof, said wings having a leading edge and said wings trailing rearward toward the tail end of the decoy cover;
said decoy having a flexible rod transversing through the middle portion thereof, and forward of the leading edge of the wings, said flexible rod protruding beyond the wings;
said flexible rod having at each end thereof, an attachment means for attaching at least one moveable feather such that each of the moveable feathers is free to move.

2. A decoy having the cover as claimed in claim 1.

3. A decoy having the cover as claimed in claim 1 wherein the simulated feathers are manufactured from a material selected from the group consisting of plastics, cloth, fabric, wood, wood fiber, hides and textile.

4. A decoy having a cover as claimed in claim 1 wherein the simulated feathers are attached by a method selected from the group consisting of gluing, sewing, tying, hooking, pinning, adhesion, stapling, tacking, wiring, molding, grafting, cementing, knitting, stitching, taping, and bonding.

5. A decoy having a cover as claimed in claim 1 wherein said cover simulates a fowl selected from the group consisting of geese, turkey, pheasant, duck, crow, partridge, grouse, pigeon, chicken, crane, dove, owl, woodcock, quail, bobwhite, chucker, merganser and snipe.

6. A decoy cover, said decoy cover comprising a main body, having an outside surface, said main body being capable of being configured to the outside surface of a decoy;
said decoy cover having a neck end and a tail end and a middle portion;
said neck end, tail end, and middle portion having a fastening means located thereon;
the outside surface of the decoy cover is comprised primarily of real feathers attached thereto, said feathers mimicking the feathers of a fowl;
the outside surface having feathered wings attached thereto and near the middle portion thereof; said wings having a leading edge and said wings trailing rearward toward the tail end of the decoy cover, said wings composed of real feathers.

7. A decoy having the cover as claimed in claim 6.

8. A decoy having a cover as claimed in claim 6 wherein the real feathers are attached by a method selected from the group consisting of gluing, sewing, tying, hooking, pinning, adhesion, stapling, tacking, wiring, molding, grafting, cementing, knitting, stitching, taping, and bonding.

9. A decoy having a cover as claimed in claim 6 wherein the feathers are selected from the group consisting of geese, turkey, pheasant, duck, crow, partridge, grouse, pigeon, chicken, crane, dove, owl, woodcock, quail, bobwhite, chucker, merganser and snipe.
